(19) United States
(12) Patent Application Publication
(10) Pub. No.: US 2010/0105434 A1
(43) Pub. Date: Apr. 29, 2010

(54) Data management method and apparatus using subscriber identity module

(75) Inventor: Jeong Yun Hong, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/589,362

(22) Filed: Oct. 22, 2009

(30) Foreign Application Priority Data
Oct. 24, 2008 (KR) 10-2008-0105009

(51) Int. Cl. H04B 1/38

(52) U.S. Cl. 455/558

(57) ABSTRACT

A data management method and apparatus using a subscriber identity module is provided that includes a mobile terminal, which includes an first interface, for establishing at least one input/output line and a Subscriber Identity Module (SIM), which includes a second interface coupled to the first interface, for establishing the at least one input/output line with the mobile terminal. The mobile terminal can instructs the SIM to set multiple input/output lines for communication of data requiring the multiple input/output lines-requiring according to the user command.

### CROSS-REFERENCE TO RELATED APPLICATION(S) AND CLAIM OF PRIORITY

The present application is related to and claims priority to an application entitled “DATA MANAGEMENT METHOD AND APPARATUS USING SUBSCRIBER IDENTITY MODULE” filed in the Korean Intellectual Property Office on Oct. 24, 2008 and assigned Serial No. 10-2008-0105009, the contents of which are incorporated herein by reference.

### TECHNICAL FIELD OF THE INVENTION

The present invention relates to a data management and, in particular, to a data management method and apparatus using a subscriber identity module.

### BACKGROUND OF THE INVENTION

In the mobile communication systems using the Global System for Mobile Telecommunication (GSM) standard, the mobile terminal includes a Subscriber Identity Module (SIM) card that stores subscriber information related to the authentication, billing, and security. Since the SIM card is used to authenticate the subscriber to the GSM carrier, the subscriber must carry the SIM card to receive GSM services by means of a GSM terminal. As an must-carry item, the SIM card may be used for other purposes. For instance, the SIM card can be used as a portable storage device for storing small size data such as phonebook and Short Message Service (SMS) messages, and to-do list as well as the subscriber information.

Meanwhile, with the advance of technologies, the improved applications installed in the mobile terminal increase the size and number of types of data. For instance, the multimedia applications such as video and audio players can require more sophisticate operation of the device and large storage space for processing the video and audio files. Also, with the diversification of the audiovisual services, the use of mobile terminal for playing large sizes of multimedia data is rapidly increasing. In order to carry the large volume of multimedia data, various portable storage media are developed and used. If the SIM card as a must-carry item is used for storing the user data, it can be negated to carry the additional storage device. However, the SIM card is limited in storage capacity and data transfer rate, thereby may not appropriate for storing multimedia data requiring large storage space and high data transfer rate. Accordingly, there is a need to develop a technique for expanding utilization of a SIM card so as to store large volume of data and interfacing the SIM card with a host device at high data transfer rate.

### SUMMARY OF THE INVENTION

To address the above-discussed deficiencies of the prior art, it is a primary object to provide a data management method and apparatus using a Subscriber Identity Module (SIM) card.

In accordance with an exemplary embodiment of the present invention, a data management method for a mobile terminal includes receiving a user command requesting data communication with a Subscriber Identity Module (SIM); determining whether a data indicated by the command is a multiple input/output lines-requiring data; instructing, when the data indicated by the command is a multiple input/output lines-requiring data, the SIM to set multiple input/output lines; and transmitting the multiple input/output lines-requiring data to the SIM or receiving the multiple input/output lines-requiring data from the SIM through the multiple input/output lines according to the user command.

In accordance with another exemplary embodiment of the present invention, a data management apparatus includes a mobile terminal that includes an first interface to establish at least one input/output line; and a Subscriber Identity Module (SIM) that includes a second interface coupled to the first interface to establish the at least one input/output line with the mobile terminal, wherein the mobile terminal instructs, when a user command requesting communication of multiple input/output lines-requiring data with the SIM is received, the SIM to set multiple input/output lines and transmits the multiple input/output lines-requiring data to the SIM or receives the multiple input/output lines-requiring data from the SIM through the multiple input/output lines according to the user command.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram illustrating a configuration of a mobile terminal to which a SIM card is attached according to an exemplary embodiment of the present invention;

FIG. 2A illustrates a schematic diagram for a configuration of a SIM card according to an exemplary embodiment of the present invention;

FIG. 2B illustrates a schematic diagram for a configuration of data lines of the SIM card of FIG. 2A;

FIG. 2C illustrates a schematic diagram for a configuration of a SIM card according to another exemplary embodiment of the present invention;

FIG. 2D illustrates a schematic diagram for a configuration of data lines of the SIM card of FIG. 2C;

FIG. 3 illustrates a diagram for a storage structure of the memory of the SIM card of FIG. 1;

FIG. 4 illustrates a flowchart for a data management method using a SIM card from the viewpoint of the mobile terminal according to an exemplary embodiment of the present invention; and

FIG. 5 illustrates a flowchart for a data management method using a SIM card from the viewpoint of the SIM card according to an exemplary embodiment of the present invention.

### DETAILED DESCRIPTION OF THE INVENTION

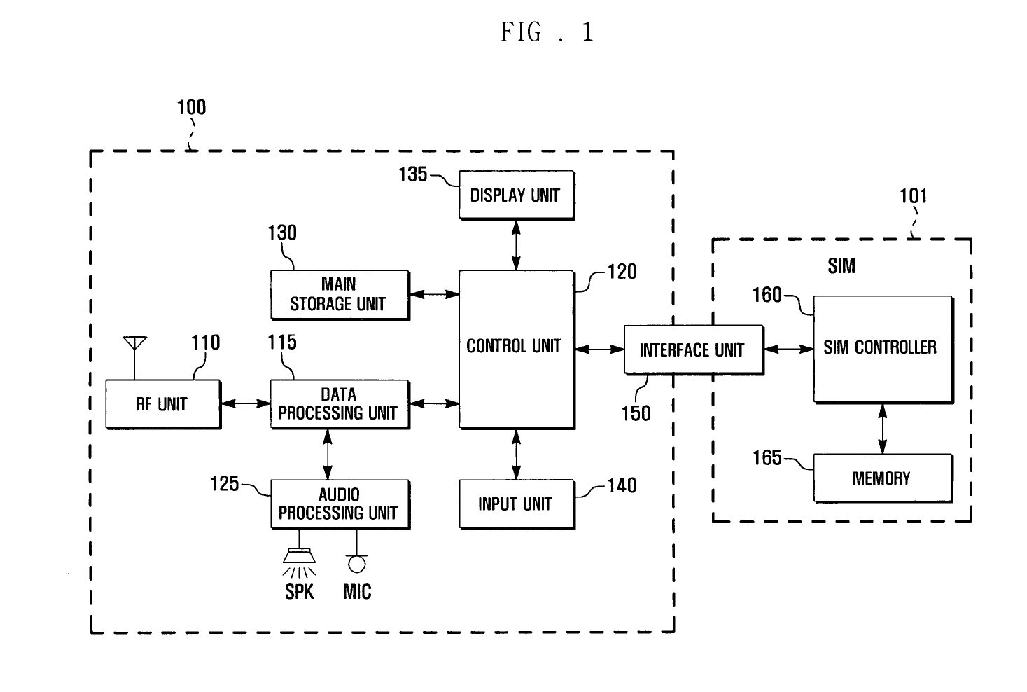

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile terminal.

FIG. 1 illustrates a block diagram for a configuration of a mobile terminal to which a SIM card is attached according to an exemplary embodiment of the present invention. Although the data management method and apparatus is primarily directed to the use of a SIM, the present invention is not limited thereto. For example, the data management method and apparatus can be applied to Universal Subscriber Identity Module (USIM) for use in the Universal Mobile Telecommunications System (UMTS), Universal Integrated Circuit Card (UICC), and other storage media used for storing subscriber information required for access to communication systems based on various communication standards.

Referring to FIG. 1, the mobile terminal 100 includes a Radio Frequency (RF) unit 110, a data processing unit 115, a control unit 120, an audio processing unit 125, a main storage unit 130, a display unit 135, an input unit 140, and a SIM interface unit 160. A SIM card 101 is attached to the mobile terminal 100 via the SIM interface unit 160. The SIM card includes a SIM controller 160 and a memory 165. Although the mobile terminal is depicted with the function blocks constituting a mobile phone, the present invention is not limited to the mobile phone. For example, the mobile terminal can be any of a number of electric devices including, for example, a cellular phone, a Personal Digital Assistant (PDA), a Smartphone, and equivalent devices that include an interface to and from which a SIM card is attachable and detachable and that can transmit and receive data.

The mobile terminal 100 performs radio communication by means of the RF unit 110, data processing unit 115, and audio processing unit 125. The RF unit 110 is responsible for establishing a wireless call connection with a base station for voice and data communications such as Short Messaging Service (SMS) and Multimedia Message Service (MMS). The mobile terminal 100 can receive the data to be stored in the memory 165 of the SIM card 101 by means of the RF unit 110. The RF unit includes an RF transmitter for up-converting and amplifying the transmission signal and low noise amplifying and down-converting the received signal. The data processing unit 115 processes the voice data input by the audio processing unit 125 and the alphanumeric data input through the input unit 115. The data processing unit 115 can include a transmitter that can encode the transmission signal and modulate the encoded signal and a receiver that can demodulate the received signal and decode the demodulated signal. That is, the data processing unit 115 includes a modem and a codec. Here, the codec can include a data codec for processing packet data and an audio codec for processing audio signal including voice. The audio processing unit 125 processes the audio signal input from the data processing unit 115 and outputs the processed audio signal through a speaker (SPK) in the form of an audible sound wave and processes the audio signal including voice input through a microphone (MIC) and outputs the processed audio signal to the data processing unit 115.

The control unit 120 can control the entire operations of the mobile terminal and can control signaling among the internal function blocks. The control unit 120 can integrate the functions of the data processing unit 115. The control unit 120 also can control the interoperation with the SIM card 101. Particularly, in an exemplary embodiment of the present invention, the control unit 120 controls data exchange with the SIM card 101. For example, the control unit 120 can generate commands for reading and writing data in response to a read and write requests for specific data and can transmit the commands to the SIM card 101 through input/output lines (hereinafter call IO lines). Here, the data can be transmitted to and received from the SIM card 101 through multiple IO lines. Additionally, the data can be multimedia data. The data exchange between the mobile terminal and SIM card is described in detail later.

The main storage unit 130 can include a program region and a data region. The program region can store the Operating System (OS) for booting the mobile terminal 100 and various application programs, for composing an idle mode screen and supplementary functions, such as, for example, audio and video playback functions. When a specific function is requested by the user, the mobile terminal executes the requested functions by means of the corresponding applications under the control of the control unit 120. The data region can store various application data and user data. The display unit 135 can display visual data, including application execution screen and alphanumeric data input by the user manipulating keys of the input unit 140. The display unit 135 can be implemented with a Liquid Crystal Display (LCD) panel. In embodiments wherein the LCD panel supports a touch-screen function, the display unit 135 can be configured as a part of the input unit 140. The input unit 140 is provided with a plurality of alphanumeric and function keys that can receive the alphabetic and numeric data and instructions that can set and execute functions of the mobile terminal 100 and transferring the signals corresponding to the keystrokes to the control unit 120. The input unit 140 can be implemented with at least one of a touch pad and a keypad, and a touch-screen.

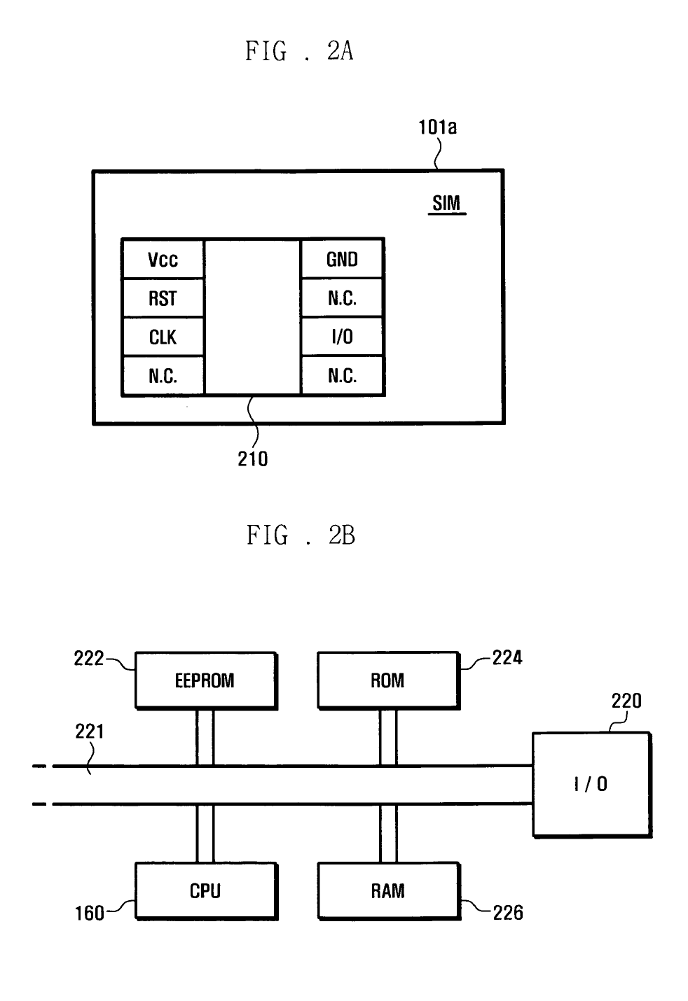

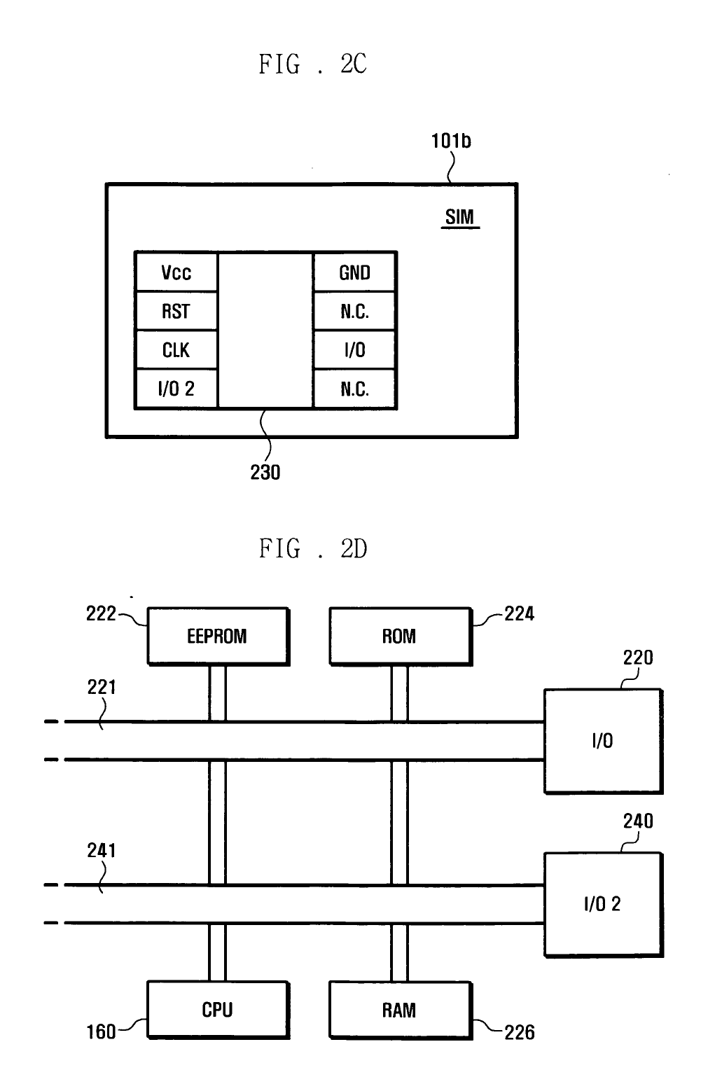

The interface unit 150 is composed of connection pins for connecting the SIM card 101 to the mobile terminal 100 electrically. The connection pins correspond to the connection pins of the SIM cards 101 such that the SIM card 101 is electrically coupled to the mobile terminal 100. Once the SIM card 101 is coupled to the mobile terminal 100, the mobile terminal 100 and SIM card 101 can exchange data through the signal lines established by the connection pins. The connection pins of the SIM card 101 are described in detail with reference to FIGS. 2A to 2C later. Since the connection pins of the interface unit 150 correspond to those of the SIM card 101, detailed description about the connection pins of the mobile terminal 100 is omitted.

The SIM controller 160 can control the actions of the SIM card 101 in response to the commands received from the mobile terminal 100. More particularly, when a data exchange command is received from the mobile terminal 100, the SIM controller 160 configures the IO lines to transmit and receive data to and from the mobile terminal 100. The data received through the plural IO lines are merged and then stored in the memory 165. The memory 165 stores the subscriber information for authenticating the subscriber to the network and user data. The memory 165 can be a storage device expanded physically in storage capacity for storing large volume of data, such as, for example multimedia data. The memory 165 can be expanded in size by adding a flash memory such as NAND flash memory for securing large storage space. In an exemplary embodiment of the present invention, the term “multimedia data” is used to represent all the types of data including the audio and video data as well as the messaging service data such as SMS and MMS messages.

FIG. 2A illustrates a schematic diagram for a configuration of a SIM card according to an exemplary embodiment of the present invention, and FIG. 2B illustrates a schematic diagram for a configuration of data lines of the SIM card of FIG. 2A.

Referring to FIGS. 2A to 2B, the SIM card 101b is provided with a connection interface 210 for establishing a connection with the mobile terminal 100 of FIG. 1. The connection interface 210 includes a power supply pin (Vcc), a ground pin (GND), a reset pin (RST), a clock pin (CLK), an I/O pin, and 3 reserved pins (N.C.). As shown in FIG. 2a, the connection interface 210 of the SIM card 101a is provided with a single I/O pin 220, thus, the SIM card 101a can establishe a single I/O line 221 with the mobile terminal 100 by means of a single I/O pin 220 as shown in FIG. 2B. The CPU, i.e., the SIM controller 160, receives an I/O command from the mobile terminal 100 (see FIG. 1) through the I/O line 221. The SIM controller 160 also can transmit the data stored in the memory 165 to the mobile terminal 100; receive the data transmitted by the mobile terminal 100 through the single I/O line 221; and store the received data in the memory 165. In FIG. 2B, the memory 165 includes an Electrically Erasable Programmable Read-Only Memory (EEPROM) 222, a Read-Only Memory (ROM) 224, and a Random Access Memory (RAM) 226. In an exemplary embodiment of the present invention, the multimedia data are stored within the EEPROM 222.

FIG. 2C illustrates a schematic diagram for a configuration of a SIM card according to another exemplary embodiment of the present invention, and FIG. 2D illustrates a schematic diagram for a configuration of data lines of the SIM card of FIG. 2C.

As shown in FIG. 2C, the SIM card 101b can be modified by designating one of the reserved pins of the connection interface 230 as another I/O pin. The SIM controller 160 can activate multiple I/O pins 220 and 240 according to the multiple I/O line command transmitted by the mobile terminal 100. In this example, the two connection interface 230 of the SIM card 101b is provided with two I/O pins 220 and 240, thus, the SIM card 101b establishes two I/O lines 221 and 241 with the mobile terminal 100 by means of the I/O pins 220 and 240. The CPU, i.e., the SIM controller 160, can receive an I/O command from the mobile terminal 100 through the multiple I/O lines 221 and 241. The SIM controller 160 also can transmit the data to the mobile terminal 100; receive the data transmitted by the mobile terminal 100 through the two I/O lines 221 and 241; and store the received data within the memory 165. In FIG. 2d, the memory 165 includes an EEPROM 222, a ROM 224, and a RAM 226. In an exemplary embodiment of the present invention, the multimedia data are stored within the EEPROM 222.

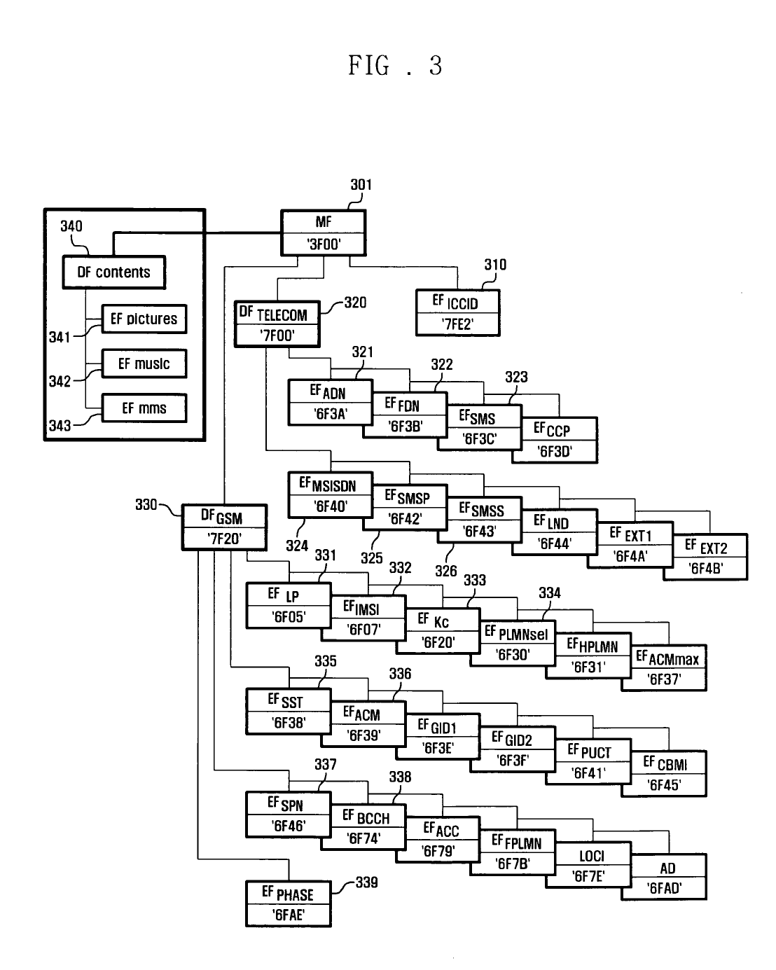

FIG. 3 illustrates a diagram for a storage structure of the memory of the SIM card of FIG. 1. The file structure of the data stored in the memory 165 of FIG. 1 can vary according to the storage methodology supported by the management protocol of the SIM card. In an exemplary embodiment of the present invention, the data are stored in the exemplary file structure of FIG. 3.

As shown in FIG. 3, the memory 165 is organized in a hierarchical structure. The memory includes a Master File (MF) 301 on the first level of the hierarchical file structure and Elementary Files (EFs) under the MF. A set of EFs can be grouped into a Directory File (DF). In the example of FIG. 3, there are a Telecom DF 320, a GSM DF 330, and a Contents DF (340). The Telecom DF 320 is a DF grouping the EFs containing data related to the telecommunication, the GSM DF 330 is a DF grouping the EFs containing data related to the GSM communication, and the DF Contents 340 is a DF grouping EFs containing data related to multimedia data. More particularly, the Telecom DF 320 can include an abbreviated dialing numbers EF 321, a fixed dialing numbers EF 322, a Short Message Service (SMS) EF 323, a Mobile Station International Integrated Service Digital Network (MSISDN) EF 324, an SMS Parameters (SMSP) EF 325, and an SMS Status (SMSS) EF 326. The GSM DF 330 can include a Language Preference (LP) EF 331, an International Mobile Station Identity (IMSI) EF 332, a Ciphering Key (KC) EF 333, a Public Land Mobile Network (PLMN) Selector EF 334, a SIM Service Table (SST) EF 335, an Accumulated Call Meter (ACM) EF 336, a Service Provider Name (SPN) EF 337, a Broadcast Control Channel (BCC) EF 338, and a Phase EF 339. The DF Contents 340 can include a Picture EF 341 containing picture-related data, a Music EF 342 containing audio-related data, and a Multimedia Messaging Service (MMS) EF 342. Also, an Integrated Circuit Card Identification (ICCID) EF 310 is under the MF 301. The file structure is depicted according to the international standard except for the DF Contents 340 can be modified depending upon the SIM design requirements. The DF Contents 340 is illustrated as an example, and thus, the file name can be changed.

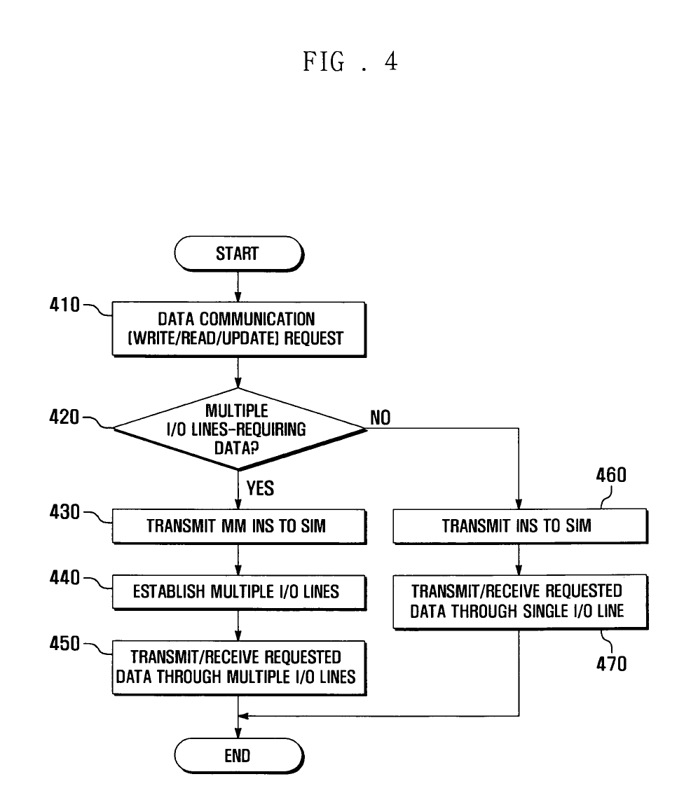

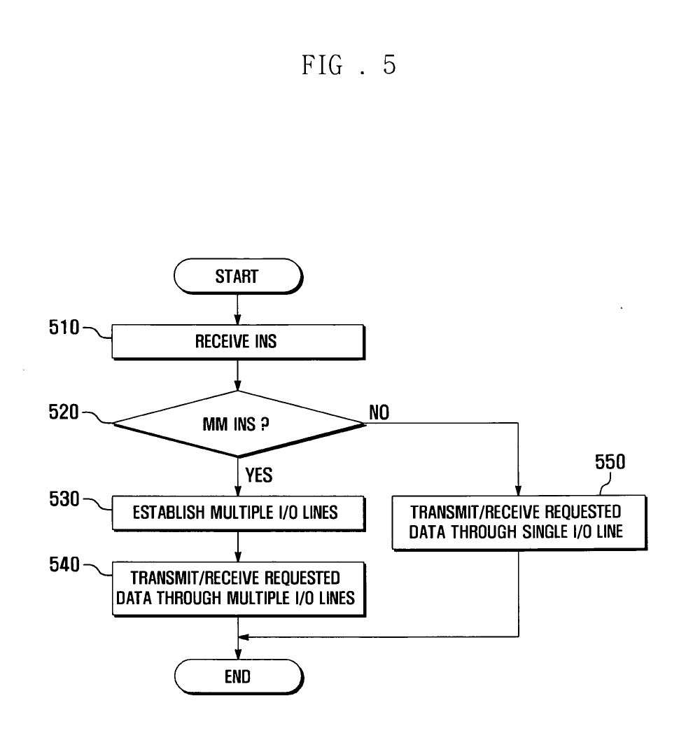

How the multimedia data are stored, read, and updated within the memory 165 of the SIM card 101 in the form of the file structure of FIG. 3 through a single or multiple I/O lines established with the mobile terminal is described in detail with reference to FIGS. 4 and 5.

FIG. 4 illustrates a flowchart for a data management method using a SIM card from the viewpoint of the mobile terminal according to an exemplary embodiment of the present invention. In the example illustrated in FIG. 4, the SIM card 101 and the mobile terminal 100 are connected through the interface unit 150 and synchronized for exchanging data.

Referring to FIG. 4, the control unit 120 of the mobile terminal receives a data handling signal, such as, for example, data write/read/update request signal, corresponding to a key input by the user through the input unit 140 (block 410). Once the data handling signal is received, the control unit 120 determines whether the data indicated by the data handling signal is a data requiring multiple I/O lines (block 420). Here, the data requiring multiple I/O lines is a data having a specific data type requiring multiple I/O lines to transmit to or receive from the SIM card 101 and thus whether the data requires multiple I/O lines is determined by the type of data to be handled. In an exemplary embodiment of the present invention, the data type requiring multiple I/O lines is a multimedia relatively large in size. However, other criteria, such as, for example, data size, can be used for determining whether to use multiple I/O lines.

If the data indicated by the dada handling signal is a multimedia data requiring multiple I/O lines, the control unit 120 generates a MultiMedia data instruction (hereinafter called ‘MM INS’) and transmits the MM INS to the SIM controller 160 of the SIM card 101 (block 430). For example, if an MM INS having a hexadecimal value of 0×21 which instructs to read a multimedia data, the SIM controller 160 received the MM INS reads the multimedia data indicated by the MM INS from the memory 165 and transmits the read multimedia data to the mobile terminal 100. Also, if an MM INS includes a hexadecimal value of 0×22, which instructs to store the data transmitted, the SIM controller 160 receives the data transmitted by the mobile terminal 100 and stores the received data in the memory 165. Also, if an MM INS includes a hexadecimal value of 0×23, which instructs to update the data indicated, the SIM controller 160 updates the data indicated by the MM INS with the data transmitted by the mobile terminal 100.

After transmitting the MM INS, the control unit 120 sets multiple I/O lines to be used to transmit or receive the multimedia data (block 440). At this time, the multiple I/O lines are activated by designating at least one of the reserved pins (N.C.) of the connection interface 230 as the I/O pin in addition to the designated I/O pin as shown in FIG. 2c. Consequently, at least two I/O lines, i.e., the I/O line 221 established by means of the dedicated I/O pin and the I/O line 241 established optionally, are activated as shown in FIG. 2D. After activating multiple I/O lines, the control unit 120 can set buffers within the main storage unit 130 to control the flow of the data for the respective I/O lines. For example, when two I/O lines 221 and 241 are activated, as shown in FIG. 2D, the control unit 120 sets two buffers for the respective I/O lines 221 and 241. Once the multiple I/O lines are set successfully, the control unit 450 can transmit the data to the SIM card 101 or can receive the data from the SIM card 101 via the multiple I/O lines according to the MM INS. That is, if the MM INS is a data write instruction, the control unit 120 can transmit the data to be stored in the memory 165 to the SIM card 101 through the multiple I/O lines. Otherwise, if the MM INS is a data read instruction, the control unit 120 receives the data transmitted by the SIM card 101 through the multiple I/O lines. Alternatively, if the MM INS is a multimedia data update instruction, the control unit 120 transmits the data to update the target multimedia data stored in the memory 165 to the SIM card 101 through the multiple I/O lines. In case of reading the data from the memory 165 of the SIM card 101, the control unit 120 merges the data received through different I/O lines into a single file.

Returning to block 420, if the data indicated by the data handling signal is not a multimedia data requiring multiple I/O lines, the control unit 120 generates a normal data instruction (hereinafter called ‘INS’) and transmits the INS to the SIM controller 160 of the SIM card 101 (block 460). Here, the INS is an instruction generated when transmitting or receiving the data through a single I/O line. After transmitting the INS to the SIM card 101, the control unit 120 transmits the data through the single I/O line to the SIM card 101 or receives the data through the single I/O line from the SIM card 101 according to the INS (block 470). That is, if the INS is a data write instruction, the control unit 120 transmits the data, to be stored in the memory 165, to the SIM card 101. Otherwise, if the INS is a data read instruction, the control unit 120 receives the data read from the memory 165 and transmitted by the SIM controller 160 through the single I/O line. Alternatively, if the INS is a data update instruction, the control unit 120 transmits the data to update the target data stored in the memory 165 to the SIM card 101 through the single I/O line.

FIG. 5 illustrates a flowchart for a data management method using a SIM card from the viewpoint of the SIM card according to an exemplary embodiment of the present invention. In the example illustrated in FIG. 5, the SIM card 101 and the mobile terminal 100 are connected through the interface unit 150 and synchronized for exchanging data.

Referring to FIG. 5, the SIM controller 160 of the SIM card 101 receives an INS instructing data exchange (block 510). If the INS instructing data exchange, the SIM controller 160 determines whether the INS is an MM INS requiring multiple I/O lines (block 520). If the INS is an MM INS, the SIM controller 160 activates multiple I/O pins to establish multiple I/O lines (block 530). At this time, the SIM controller 160 designates at least one of the reserved pins (N.C.) of the connection interface 230 as I/O pin in addition to the dedicated I/O pin as shown in FIG. 2C. Consequently, at least two I/O lines, i.e., the I/O line 221 established by means of the dedicated I/O pin and the I/O line 241 established optionally, are activated as shown in FIG. 2D. After activating multiple I/O lines, the control unit 120 can sets buffers within the memory 165 to control the flow of the data for the respective I/O lines. For example, when two I/O lines 221 and 241 are activated, as shown in FIG. 2D, two buffers are set for the respective I/O lines 221 and 241. Once the multiple I/O lines are successfully set, the SIM controller 160 transmits the data to the mobile terminal or receives data from the mobile terminal 100 via the multiple I/O lines according to the MM INS (block 540). That is, if the MM INS is a multimedia data write instruction, the SIM controller 160 receives the multimedia data transmitted by the mobile terminal 100 through the multiple I/O lines and writes the received multimedia data into the memory 165. At this time, the received data are stored into an EF in the file structure of the memory 165 as shown in FIG. 3. The MM INS can include the information on the EF in which the data are to be stored. The data received through the multiple I/O lines are merged and then stored. If the MM INS is a multimedia data read instruction, the SIM controller 160 reads the multimedia data indicated by the MM INS from the memory 165 and transmits the read multimedia data to the mobile terminal 100 through the multiple I/O lines. At this time, the MM INS can include the information on the file containing the multimedia data to be read from the memory 165. If the MM INS is a multimedia data update instruction, the SIM controller 160 receives the data transmitted by the mobile terminal 100 through the multiple I/O lines and updates the target multimedia data with the received data.

Returning to block 520, if the INS is not an MM INS, the SIM controller 160 activates a single I/O line and receives the data transmitted by the mobile terminal 100 or transmits the date indicated by the INS through the single I/O line (block 550). That is, if the INS is a data write instruction, the SIM controller 160 receives the data transmitted by the mobile terminal 100 through the single I/O line and writes the received data into the memory 165. At this time, the received data are stored into an EF in the file structure of the memory 165 as shown in FIG. 3. The INS can include the information on the EF in which the data are to be stored. If the INS is a data read instruction, the SIM controller 160 reads the data indicated by the INS from the memory 165 and transmits the read data to the mobile terminal 100 through the single I/O line. At this time, the INS can include the information on the file containing the data to be read from the memory 165. If the INS is a data update instruction, the SIM controller 160 receives the data transmitted by the mobile terminal 100 through the single I/O line and updates the target data with e received data.

As described above, the data management method and apparatus of the present invention enables the user to carry the user data using the SIM card, thereby negating additional storage device.

Also, the data management method and apparatus of the present invention enables the SIM card to store data relatively large in volume such as multimedia data regardless of data type, there improving utilization of the SIM card.

Furthermore, the data management method and apparatus of the present invention is capable of setting the SIM interface with multiple I/O lines to data transfer rate between the host device and SIM card, thereby solving the problems of the SIM card that are caused when transferring large volume of data.

Also, the data management method and apparatus using a SIM card according to the present invention is advantageous to expand the utilization of the SIM card by improving the SIM card to store the data relative large in size and requiring high data transfer rate, while negating additional storage device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A data management method for a mobile terminal, comprising:
receiving a user command requesting data communication with a Subscriber Identity Module (SIM);
determining whether a data indicated by the command is a multiple input/output lines-requiring data;
instructing, when the data indicated by the command is a multiple input/output lines-requiring data, the SIM to set multiple input/output lines; and
transmitting the multiple input/output lines-requiring data to the SIM or receiving the multiple input/output lines-requiring data from the SIM through the multiple input/output lines according to the user command.

2. The data management method of claim 1, wherein the multiple input/output lines-requesting data is a multimedia data.

3. The data management method of claim 1, wherein the user command is one of: a data write command; a data read command; and a data update command.

4. The data management method of claim 1, further comprising establishing the multiple input/output lines by designating at least one of reserved lines as an optional input/output line in addition to a dedicated input/output line.

5. The data management method of claim 1, further comprising setting buffers as many as a number of multiple input/output lines after instructing the SIM to set multiple input/output lines.

6. The data management method of claim 1, further comprising merging, when receiving the multiple input/output lines-requiring data, the data received through the multiple input output lines.

7. The data management method of claim 3, further comprising storing, when the user command is a data write command, the data into an Elementary File (EF) within the SIM.

8. The data management method of claim 7, wherein the data is stored in a hierarchical file structure comprising at least one EF on lowest level, at least one Dedicated File (DF) placed above the at least EF and grouping at least two EFs, and a Master File (MF) on the highest level and including at least one of EF and DF.

9. A data management apparatus comprising:
a mobile terminal comprising a first interface, the mobile terminal configured to establish at least one input/output line; and
a Subscriber Identity Module (SIM) comprising a second interface coupled to the first interface, the SIM configured to establish the at least one input/output line with the mobile terminal,
wherein the mobile terminal is configured to instruct, when a user command requesting communication of multiple input/output lines-requiring data with the SIM is received, the SIM to set multiple input/output lines and wherein the mobile terminal further is configured to at least one of:
transmit the multiple input/output lines-requiring data to the SIM; and
receive the multiple input/output lines-requiring data from the SIM through the multiple input/output lines according to the user command.

10. The data management apparatus of claim 9, wherein the multiple input/output lines-requesting data is a multimedia data.

11. The data management apparatus of claim 9, wherein the user command is one of: a data write command; a data read command; and a data update command.

12. The data management apparatus of claim 9, wherein each of the first and second interfaces comprises a power supply pin, a ground pin, a reset pin, a clock pin, an input/output pin and three reserved pins (N.C.).

13. The data management apparatus of claim 12, wherein the SIM designates at least one of the three reserved pins (N.C.) of the second interface as an optional input/output pin.

14. The data management apparatus of claim 9, further comprising a memory configured to store the data received from the mobile terminal in a hierarchical file structure.

15. The data management apparatus of claim 14, wherein the hierarchical file structure comprises at least one EF on lowest level, at least one Dedicated File (DF) placed above the at least EF and grouping at least two EFs, and a Master File (MF) on the highest level and including at least one of EF and DF.

16. The data management apparatus of claim 9, wherein the SIM is configured to merge the data received from the mobile terminal through multiple input/output lines and stores merged data in a memory.

17. A mobile terminal comprising:
a control unit configured to establish at least one input/output line; and
an interface unit adapted to couple to a Subscriber Identity Module (SIM),
wherein the control unit is configured to instruct, when a user command requesting communication of multiple input/output lines-requiring data with the SIM is received, the SIM to set multiple input/output lines and wherein the control unit further is configured to at least one of:
transmit the multiple input/output lines-requiring data to the SIM; and
receive the multiple input/output lines-requiring data from the SIM through the multiple input/output lines according to the user command.

18. The mobile terminal of claim 17, wherein the multiple input/output lines-requesting data is a multimedia data.

19. The mobile terminal of claim 17, wherein the user command is one of: a data write command; a data read command; and a data update command.

20. The mobile terminal of claim 17, further comprising a memory configured to store the data received from the mobile terminal in a hierarchical file structure.
